(19) United States
(12) Patent Application Publication
(10) Pub. No.: US 2004/0107518 A1
(43) Pub. Date: Jun. 10, 2004

(54) Hetero-anellated ortho-aminophenols and their use as dye components

(76) Inventor: Carsten Plueg, Seeheim-Jugenheim (DE)

Correspondence Address: CLARIANT CORPORATION, INTELLECTUAL PROPERTY DEPARTMENT, 4000 MONROE ROAD, CHARLOTTE, NC, 28205, US

(21) Appl. No.: 10/415,579

(22) PCT Filed: Nov. 7, 2001
(86) PCT No.: PCT/IB01/02094

(30) Foreign Application Priority Data
Nov. 7, 2000 (GB) 0027151.0

(51) Int. Cl. C04B 14/00

(52) U.S. Cl. 8/662; 106/400

(57) ABSTRACT

The invention provides heteroanellated aminophenols of the general formula (I)

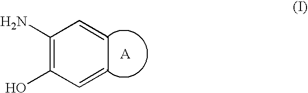

wherein ring A has the meaning given in claim 1, as well as a process for the preparation of such aminophenols. Furthermore, the invention provides azo compounds of the general formula (II)

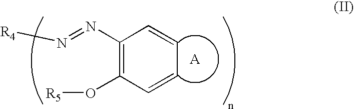

wherein ring A, n and the substituents have the meaning given in claim 3, as well as a process for the preparation of those compounds from aminophenols. In addition, the invention provides azomethine compounds of the general formula (III)

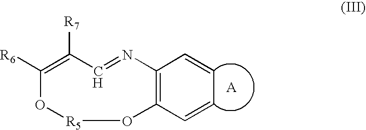

wherein ring A and the substituents have the meaning given in claim 6, as well as a process for the preparation of those compounds from aminophenols.

The invention describes the use of compounds (II) and compounds (III) for the mass coloration of substrates, as colorants in electrophotographic toners and developers, in powders and powder coating materials, in ink-jet inks and in cosmetic compositions.

The present invention relates to the preparation of hetero-anellated ortho-aminophenols and to their conversion to pigments and dyestuffs for the mass coloration of substrates, as colorants in electrophotographic toners and developers, in powders and powder coating materials, in inkjet inks and cosmetics.

Ortho-aminophenols are important intermediates for the preparation of dyestuffs and pigments, such as phenoxazines, triphendioxazines, azomethin and azo compounds, metallized or non-metallized.

These compounds are principally prepared by one of the following types of reactions: The reduction of ortho-nitroaromatics (e.g. W.-K. Xing, Y. Ogata, J. Org. Chem. 47, 1982, 3577), the reduction of ortho-nitrosophenols (e.g. M. Singh, K. Shandra, Z. Phys. Chem. 265, 1984, 977); the saponification of benzoxazolones or benzoxazoles (e.g. U.S. Pat. No. 2,836,587, DE 440659), and the reduction of ortho-arylazophenols or azooxypenols (e.g. Bamberger, Chem. Ber. 33, 1900, 1939).

In the series of heteroanellated ortho-aminophenols only one example of a 5-amino-6-hydroxybenzimidazolon was reported (A. V. Eltsov, L. S. Efros, Zh. Obshch. Khim., Engl. Ed. 29, 1953, 3655). The method of preparation requires 5-hydroxybenzimidazolones, which are coupled with diazonium salts and reduced by stannous chloride to yield 1,3-dimethyl-5-amino-6-hydroxy-1,3-dihydrobenzimidazol-2-one.

The above described method, as well as the general methods described before, are limited to special cases as the required 5-hydroxy-1,3-dihydrobenzimidazol-2-ones are difficult to obtain from highly expensive starting materials. In addition, purification steps are required, which make technical feasibility impossible. Disadvantageously, the process produces aromatic amines as by-products which causes environmental problems.

The invention relates to the preparation of novel heteroanellated ortho-aminophenols from readily available starting materials in good yields by environmentally safe techniques. Such compounds can be either isolated, optionally as salts or transformed in situ to pigments or dyestuffs in high yield.

The invention relates, more particularly, to novel heteroanellated ortho-aminophenols of the general formula (I)

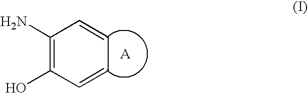

in which ring A is an anellated ring which is fused on in 3,4- or 4,5- or 5,6-position and selected from the group consisting of the moieties (1) to (6)

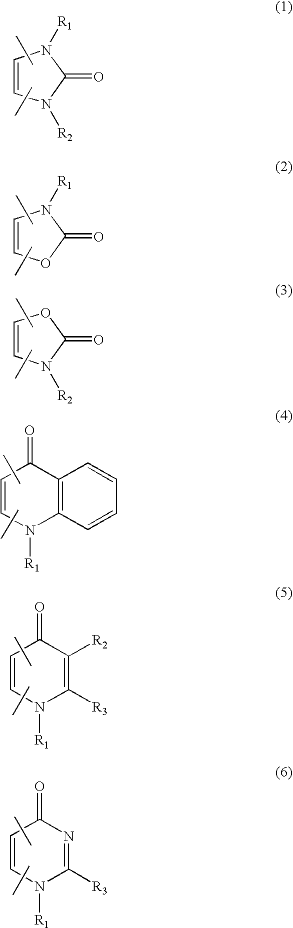

wherein R₁ and R₂ are, independently from each other, hydrogen, C₁₋₈alkyl, C₅₋₆ cycloalkyl, benzyl, phenyl or naphthyl whereby phenyl and naphthyl groups may be mono- or poly-substituted by radicals selected from the group halogen, nitro, C₁₋₈alkyl, C₅₋₆cycloalkyl, benzyl, phenyl or naphthyl, COOalkyl, C₁₋₃alkoxy or trifluoromethyl, and R₃ is, independently from R₁ and R₂, hydrogen, hydroxy, C₁₋₈alkyl, C₅₋₆ cycloalkyl, benzyl, phenyl or naphthyl whereby phenyl and naphthyl groups may be mono- or poly-substituted by radicals selected from the group halogen, nitro, C₁₋₈alkyl, C₅₋₆cycloalkyl, benzyl, phenyl or naphthyl, COOalkyl, C₁₋₃alkoxy or trifluoromethyl, with the proviso that for moiety (1) R₁ and R₂ both being methyl is excluded.

Preferred ortho-amino phenols are benzimidazolones of the formula (Ia)

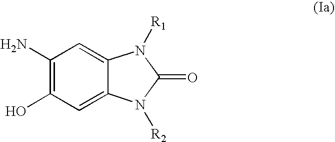

in which R₁ and R₂ have the same meaning, as defined above.

The novel ortho-amino phenols are prepared from heteroanellated N-acyl anilines by hydroxylation with manganese dioxide and saponification of the intermediate product in either acidic-or basic aqueous media.

The resulting heteroanellated ortho-aminophenol can be isolated by filtration or converted to pigments or dyestuffs without isolation.

It is well known, that diazotation of ortho-aminophenols, subsequent ortho-coupling with phenolic compounds and metallization with copper (II) salts results in compounds with good coloring properties (e.g. DE 953453, U.S. Pat. No. 2,831,849). Surprisingly, coupling of diazotised compounds of formula (I) on either aromatic compounds which carry a hydroxygroup in ortho position or aliphatic 1,3-diketo compounds, i.e. acetoacetyl amides yield compounds with good coloring properties, even without metallization. On metallization with copper even improved colorants are obtained.

In particular, diazotation by addition of sodium nitrite to the reaction mixture and subsequent coupling with couplers as acetacetyl anilines, pyrazolones, naphtholes and others gives access to azo-pigments and dyestuffs of the general formula (II)

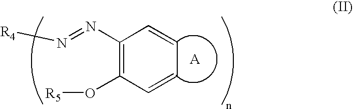

in which ring A has the meaning as in formula (I), n is 1 or 2 and wherein for n being 1 R₄ is selected from the group of 1- or 2-hydroxy naphthyl. 2-hydroxy benzene, 1-phenyl-pyrazol-5-one, 4-hydroxy-2-cumarone, 4-hydroxy-2-pyrone, 2-hydroxy-4-oxopyrido[1,2-b]pyrimidine, 4-hydroxy-2-quinolone, pyrimidine-2,4,6-trione and acetoacetyl phenylamide, for n being 2 R₄ is 1,4-dihydroxy phenyl, 1,5-dihydroxy naphtyl or bis(acetoacet)phenylenediamide, whereby pyrimidine and quinolone maybe present in the N—H, N-methyl or N-ethyl form, the benzo, phenyl and naphthyl groups may be mono- or poly-substituted by radicals selected from the group amino, phenylazo, naphthylazo, hydroxy, halogen, nitro, C₁₋₈alkyl, C₅₋₆cycloalkyl, benzyl, phenyl or naphthyl, hydroxycarbonyl, COOalkyl, C₁₋₃alkoxy, sulfonyl, aminosulfonyl, C₁₋₈alkyl, aminocarbonyl, aminosulfonyl, hydroxysulfonyl or trifluoromethyl whereby said phenyl and naphthyl can be mono- or poly-substituted by radicals selected from the group amino, hydroxy, halogen, nitro, C₁₋₈alkyl, C₅₋₆cycloalkyl, benzyl, phenyl, aminophenyl, COOalkyl, C₁₋₃alkoxy, aminocarbonyl, aminosulfonyl, C₁₋₈alkyl or trifluoromethyl said sulfonyl groups optionally being present in form of calcium, barium, ammonium or alkali, preferably sodium, salts and R₅ is hydrogen or copper, cobalt or nickel.

Preferred products are compounds of the formula (IIa)

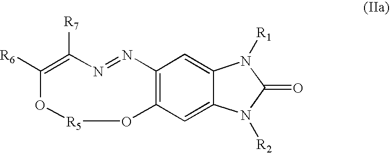

in which R₁, R₂ and R₅ have the meanings as defined above, and R₆ and R₇ together are a benzo or naphtho-ring, a 4-methyl-1-phenyl pyrazol-5-one, 2-cumarone, 2-pyrone, 4-oxopyrido[1,2-b]pyrimidine, 2-quinolone, pyrimidine-2,4,6-trione-ring or R₆ is methyl and R₇ is phenyl aminocarbonyl whereby said benzo, naphtho, phenyl and further attached benzorings can be mono- or poly-substituted by radicals selected from the group amino, phenylazo, naphthylazo, 2-hydroxyphenylazo, hydroxynaphthylazo, phenylaminocarbonyl, hydroxy, halogen, nitro, C₁₋₈alkyl, C₅₋₆cycloalkyl, benzyl, phenyl, aminophenyl, hydroxycarbonyl, COOalkyl, C₁₋₃alkoxy, aminocarbonyl, aminosulfonyl, C₁₋₈alkylaminosulfonyl, sulfonyl or trifluoromethyl, said sulfonyl groups may optionally be present in form of calcium, barium, ammonium or alkali, preferably sodium, salts

More preferred are compounds of the formulae (IIb) or (IIc)

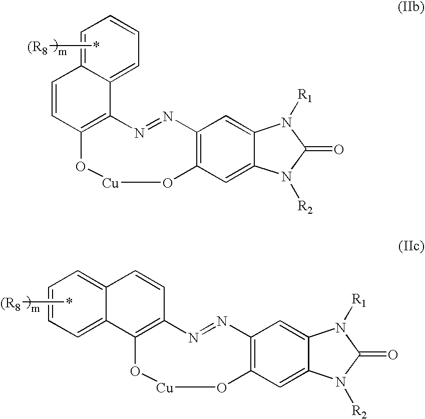

in which R₁ and R₂ have the meanings as defined above, m is 1, 2 or 3 and R₈ is located in the 3, 6 and/or 7 position of the naphthalene system and selected from hydrogen, hydroxycarbonyl, aminocarbonyl, sulfonyl, aminosulfonyl, halogen, amino, phenylazo, naphthylazo, phenylaminocarbonyl whereby phenyl and naphthyl can be mono- or poly-substituted by radicals selected from the group hydroxy, halogen, nitro, C₁₋₈alkyl, C₅₋₆cycloalkyl, benzyl, phenyl, aminophenyl, COOalkyl, C₁₋₃alkoxy, aminosulfonyl, C₁₋₈alkyl sulfonyl or trifluoromethyl said sulfonyl groups may optionally be present in form of calcium, barium, ammonium or alkali, preferably sodium, salts.

It is well known that condensation of ortho-aminophenols with aromatic ortho-hydroxycarbaldehydes and subsequent metallization with copper (II) salts results in compounds with good pigmentary properties (DE 15444004, GB 1254336). The formation of the metal complexes is believed to improve properties due to the more rigid structure.

Surprisingly, better pigmentary properties with respect to migration and overpainting fastness in paints and plastics are observed, if aminophenols of formula (I) are applied. Very surprisingly, even the non metallized compounds show good pigmentary properties even though these compounds possess more structural flexibility.

In particular, the aminophenols of formula (I), as isolated compounds or directly from the reaction mixture, can be condensed with aromatic or heterocyclic 2-hydroxyaldehydes and, optionally metallized to give azomethine compounds of the general formula (III)

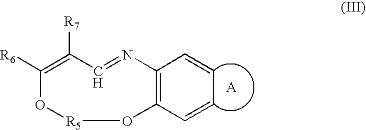

in which ring A, R₅, R₆ and R₇ have the meaning given above.

Prefered products are compounds of the formula (IIIa)

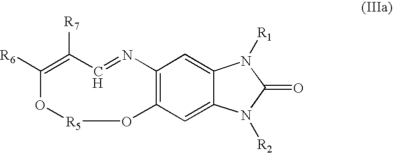

in which ring R₁, R₂, R₅, R₆ and R₇ have the meaning given above.

More preferably, metallisation with copper salts provides a compound the formula (IIIb)

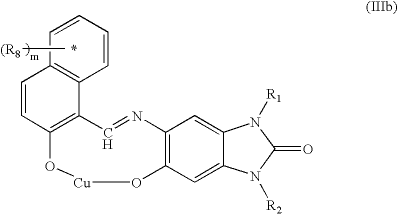

in which R₁, R₂, m and R₈ have the meanings as defined above with m preferably being 1.

Depending on the nature of the obtained colorants of the invention, the products are either pigments or dyes.

Compounds of formulae (II) and (III), having pigment properties, generate deep and clean shades. Furthermore, the pigments of the present invention possess excellent dispersability, high color strength, high weather and light fastness, high saturation and heat stability in engineering plastics.

The compounds (II) and (III) which are substituted with solubilising moieties, preferably aminosulfonyl or sulfonyl provide good solubility, high color strength and light fastness.

This invention relates to the preparation of aminophenols (I) by a technically feasable process. Amino-heterocycles are conveniently acylated by standard methods, e.g. by reaction with acetic anhydride in the presence of a base. The resulting acylamino compounds of formula (IV) are subsequently oxidized by activated manganese dioxide in the presence of sulfuric acid in either aqueous solution or in a solvent. The resulting product can be isolated or directly saponified in aqueous acidic or basic condition to provide aminophenols (I) in good yield. For reasons of stability, the aminophenols (I) are preferably isolated as salts of the acid used for the saponification step.

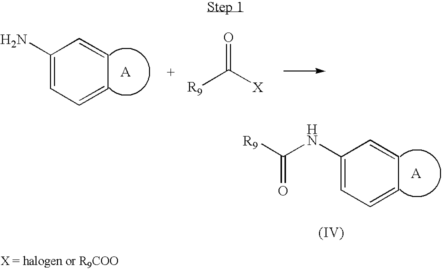

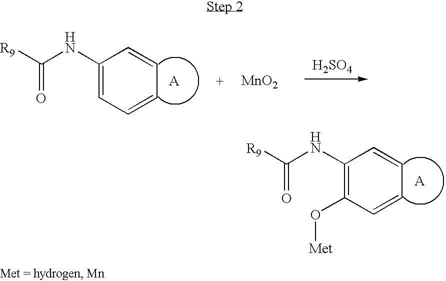

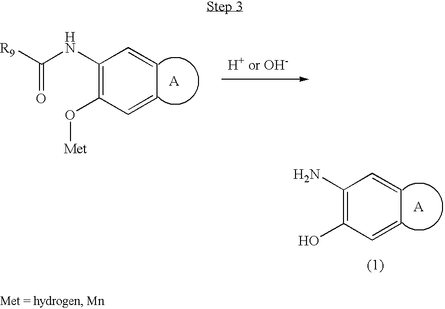

wherein ring A has the meaning as defined above and R₉ is hydrogen, methyl or phenyl.

Preferably, aminophenols bearing benzimidazolone moieties of structure (Ia) can be prepared with this methodology. The starting materials are easily accessible by a process described in EP 911337 A1.

Compounds of formula (I), preferably compounds of formula (Ia), are valuable intermediates for the preparation of pigments and colorants of formulae (II) and (III). Colorants of these types are particularly useful for dyeing of paper, leather and textiles. They can be employed for inks, water-based and solvent-based, preferably based on ethanol and methylethyl ketone.

The pigments according to the invention are suitable for the mass pigmentation of substrates including synthetic polymers, synthetic resins and regenerated fibers optionally in the presence of solvents. These substrates more particularly include oil, water and solvent based surface coatings, polyester spinning melts, polyethylene, polystyrene and polyvinyl chloride molding materials, rubber and synthetic leather. Furthermore, the pigments can be used in the manufacture of printing inks, for the mass coloration of paper and for coating and printing textiles.

The pigments according to the invention are also suitable as colorants in electrophotographic toners and developers, such as one- or two-component powder toners (also called one- or two-component developers), magnetic toners, liquid toners, polymerization toners and specialty toners (literature: L. B Schein, “Electrophotography and Development Physics”, Springer Series in Electrophysics 14, Springer Verlag, 2^{nd} Edition, 1992).

Typical toner binders are addition polymerization, polyaddition and polycondensation resins, such as styrene, styrene-acrylate, styrene-butadiene, acrylate, polyester and phenol-epoxy resins, polysulphones, polyurethanes, individually or in combination, and also polyethylene and polypropylene, which may comprise further constituents, such as charge control agents, waxes or flow assistants, or may be modified subsequently with these additives.

The pigments according to the invention are suitable, furthermore, as colorants in powders and powder coating materials, especially in triboelectrically or electrokinetically sprayable powder coating materials which are used for the surface coating of articles made, for example, from metal, wood, plastic, glass, ceramic, concrete, textile material, paper or rubber (J. F. Hughes, “Electrostatics Powder Coating” Research Studies, John Wiley & Sons, 1984).

Powder coating resins that are typically employed are epoxy resins, carboxyl- and hydroxyl-containing polyester resins, polyurethane resins and acrylic resins, together with customary hardeners. Combinations of resins are also used. For example, epoxy resins are frequently employed in combination with carboxyl- and hydroxyl-containing polyester resins. Typical hardener components (as a function of the resin system) are, for example, acid anhydrides, imidazoles and also dicyanodiamide and its derivatives, blocked isocyanates, bisacylurethanes, phenolic and melamine resins, triglycidyl isocyanurates, oxazolines and dicarboxylic acids.

In addition, the colorants according to the invention are suitable as colorants in ink-jet inks, both aqueous and non-aqueous, and in those inks, which operate in accordance with the hot-melt process.

When applied to the above-mentioned substrates the pigments are found to be resistant to migration and fast to light, and show fastness to washing, chlorite, hypochlorite and peroxide bleaching, rubbing, overspraying and solvents. Notably, the pigments display high tinctorial power, good opacity and good heat stability.

Finally, the pigments according to the invention are suitable as colorants in cosmetics.

There now follows a series of examples which serve to illustrate the invention.

### EXAMPLE 1

5-Amino-1-ethyl-6-hydroxy-1,3-dihydrobenzimidazol-2-one, hydrochloride

a) 5-Acetamino-1-ethyl-1,3-dihydrobenzimidazol-2-one

A mixture of 100 parts of 5-amino-1-ethyl-1,3-benzimidazol-2-one (97%), 46 parts of sodium hydrogencarbonate and 411 parts of dimethylformamide is treated dropwise with 62 parts of acetic anhydride at ca. 10° C. After stirring for 1 h, the mixture is diluted with 411 parts of water and filtered. The cake is washed with 1650 parts of water until salt free and dried in vacuum to obtain 100 parts of beige-brown crystals of mp 247-249° C. of the following formula

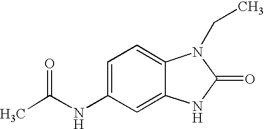

Yield: 86%

C₁₁H₁₃N₃O₂=219.2: C, 59.9; H, 6.0; N, 19.3% (found), C, 60.26; H, 5.98; N, 19.17% (required).

b) 5-Acetamino-1-ethyl-6-hydroxy-1,3-dihydrobenzimidazol-2-one, Manganese (II)Salt

A suspension of 100 parts of the amid obtained in Example 1a in 912 parts of sulfuric acid (5 wt %) is treated with 43.6 parts of manganese(IV) oxide, 90% activated, during 4 h at 0-10° C. After 1 h additional stirring at 0-10° C. The product is filtered off, washed with 3650 parts of water until salt free and suspended as wet cake in 433 parts of dimethylformamide. The mixture is refluxed for 1 h, filtered at 100° C., the cake is washed with 347 parts of dimethylformamide, 288 parts of methanol and 182 parts of water and dried in vacuum to obtain 41.4 parts of pale, fine crystals of mp>350° C. of the following formula

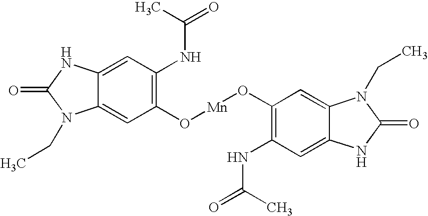

Yield: 35%

C₂₂H₂₄N₆O₆Mn=523.43: C, 50.2; H, 4.9; N, 16.6% (found), C, 50.48; H, 4.62; N, 16.06% (required)

c) 5-Amino-1-ethyl-6-hydroxy-1,3-dihydrobenzimidazol-2-one, Hydrochloride

A mixture of 100 parts of the manganese salt obtained in example 1b and 95 parts of hydrochloric acid (35 wt %) are refluxed for 24 h under nitrogen atmosphere. The dark suspension is filtered under nitrogen and the filtrate is cooled down to room temperature. The precipitate is filtered off, washed with 5 parts of water and dried in a dessiccator over sulfuric acid to obtain 41 parts of gray crystals of the following formula

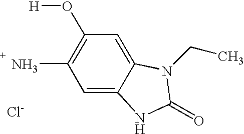

Yield: 47%

Mp 303° C. (decomp.)

C_{g}ClH₁₂N₃O₂=229.67: C, 46.4; H, 5.1; N, 18.3% (found), C, 47.07; H, 5.27; N, 18.30% (required)

¹H-NMR (D₆-DMSO, 300 MHz): δ 1.2 (t, 7 Hz, 3H, CH₃). 3.5 (br, 3H, NH₃), 3.7 (sep, 7 Hz, 2H, CH₂), 732 (s, 1H, H-4), 7.34 (s, 1H, H-7), 10.0 (br, 1H, OH). 11.2 (s, 1H, NH).

### EXAMPLE 2

Azo Colorants of 5-Amino-1-ethyl-6-hydroxy-1,3-dihydrobenzimidazol-2-one

a) Saponification and Subsequent Diazotation of 5-Acetamino-1-ethyl-6-hydroxy-1,3-di-hydrobenzimidazol-2-one, Manganese(II)Salt

A mixture of 100 parts of the manganese salt obtained in example 1b and 476-1000 parts of hydrochloric acid are refluxed for 16-24 h under nitrogen atmosphere. The dark suspension is filtered under nitrogen and the filtrate is cooled down to 0-5° C. in an ice bath, diluted with 10 parts of water and treated dropwise a 4N sodium nitrite solution until the nitrit-test (iodine-cadmium-paper) is positive. The excess of nitrite was destroyed by addition of a solution of sulfanilic acid (10 wt %). The obtained dark solution is directly used for examples 2b, 2c and 2d.

b) 4[(1-ethyl-6-hydroxy-2-oxo(1,3-dihydrobenzimidazol-5-yl)diazenyl]-3-hydroxy naphthalene-2-carboxylic Acid

A mixture of 36 parts of 3-hydroxynaphthalene-2-carboxylic acid, 25 parts of sodium hydroxide solution (30%) and 380 parts of water is stirred for 30 min and added to a mixture of 190 parts of water, 190 parts of ice, 3.8 parts of Sandopan 2N liquid (detergent) and 15 parts of glacial acetic acid. The solution obtained in example 2a is added in that way that the temperature is maintained below 10° C. and the mixture is stirred over night and filtered. The cake is washed with water until salt free and dried at 80 C. in vacuum to obtain 93 parts of crude product as dark violet crystals. TLC analysis reveals the presence of a main product that is isolated by heating the crude product (93 parts) in dimethylformamide (930 parts) to reflux for 1 h, filtration at 100° C., washing with cold dimethylformamide, methanol and water and drying at 80 C. in vacuum to obtain 27 parts of a product of the following formula

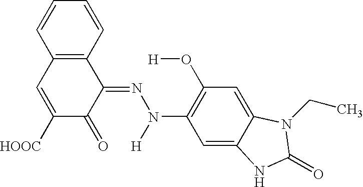

C₂₀H₁₆N₄O₅=392.4: C, 60.0; H, 5.1; N, 18.4% (found), C, 61.2; H, 4.1; N, 14.3% (required)

¹H-NMR (D₆-DMSO, 300 MHz): δ 1.2 (t, 7 Hz, 3H, CH₃), 3.7 (sep, 7 Hz, 2H, CH₂), 7.51 (t, 8 Hz, 1H, H-6), 7.61 (s, 1H, H-7′), 7.51 (t, 8 Hz, 1H, H-7), 7.94 (s, 1H, H-4′), 7.97 (d, 8 Hz, 1H, H-8), 8.52 (d, 8 Hz, 1H, H-5), 8.54 (s, 1H, H-1), 11.35 (s, 1H, NH), 13.3 (br, 1H, OH), 15.9 (br, 1H, OH).

c) 4[(1-ethyl-6-hydroxy-2-oxo(1,3-dihydrobenzimidazol-5-yl)diazenyl]-5-hydroxy-3-methyl-5-phenylpyrazolone

A mixture of 33.3 parts of 5-hydroxy-3-methyl-1-phenylpyrrazolone, 25 parts of sodium hydroxide solution (30%) and 380 parts of water is stirred for 30 min and treated with 3.8 parts of Sandopan 2N liquid (detergent) and 21 parts of glacial acetic acid. The mixture is treated dropwise with the solution obtained in example 2a in that way that the temperature is maintained at 10° C. and the pH is adjusted to 4-5 by time-to-time addition of sodium acetate. The mixture is filtered, the cake is washed with water until salt free and dried at 80° C. in vacuum to obtain 103 parts of crude product as red crystals. Recrystallisation from dimethylformamide allows the isolation of a pure product by the following formula

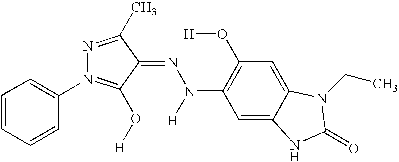

C₁₉H₁₈N₆O₃=378.4: C, 60.4; H, 4.7; N, 22.7% (found), C, 60.3; H, 4.8; N, 22.2% (required)

d) 3[(1-ethyl-6-hydroxy-2-oxo(1,3-dihydrobenzimidazol-5-yl)diazenyl]-acetoacet-4-methoxyanilide

A mixture of 79 parts of acetocetanilide, 238 parts of sodium acetate and 950 parts of water is cooled to 10° C. and treated dropwise with the solution obtained in example 2a in that way that the temperature is maintained below 10° C. and the pH is adjusted to 7-8 by time-to-time addition of sodium hydroxide solution of 30%. The mixture is stirred for 1 h and filtered, the cake is washed with water until salt free and dried at 80° C. in vacuum to obtain 138.5 parts of crude product as yellow crystals. TLC analysis reveals the presence of a main product that is to purified by recrystalisation from dimethylformamide to give a product of the following formula

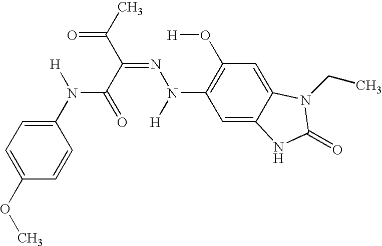

C₁₉H₁₉N₅O₄=411.4: C, 59.9; H, 5.2; N, 17.7% (found), C, 58.4; H, 5.15; N, 17.3% (required).

¹H-NMR (D₆-DMSO+NaOD, 300 MHz): δ 0.75 (t, 7 Hz, 3H, CH₂—CH₃), 2.43 (s, 3H, CO—CH₃), 3.46 (m, 2H, CH₂), 3.63 (s, 3H, OCH₃), 6.41 (d, 8.6 Hz, 2H, H-2′), 6.49 (s, 1H, H-7), 6.55 (d, 8.6 Hz, 2H, H-3′), 7.42 (s, 1H, H-4), all NH or OH were not detected under these conditions.

e) 3,3′-di[(1-ethyl-6-hydroxy-2-oxo(1,3-dihydrobenzimidazol-5-yl)diazenyl]-bisacetoacet-1,4-phenylendiamide

Coupling as described in example 2d of the solution obtained in 2a on 0.5 equimol of bisacetoacet-1,4-phenylendiamide yields a orange-yellow compound of the following formula

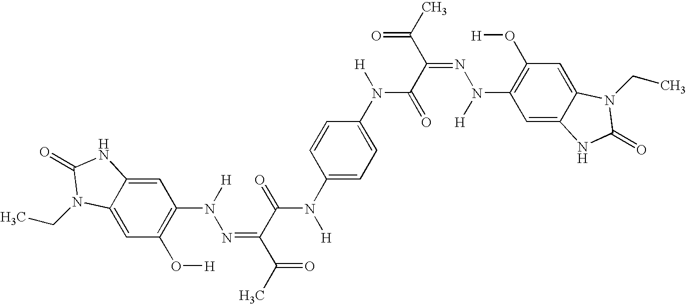

Yield: 96%

IR: δ(cm⁻¹) 1645-1600 (br), 1563, 1474, 1433, 747

### EXAMPLE 3

Azomethine Colorants of 5-Amino-1-ethyl-6-hydroxy-1,3-dihydrobenzimidazol-2-one

a) Condensation with Salicylaldehyde and Metalisation with Copper (II) Sulfate

A mixture of 100 parts of the manganese complex of example 1b and 956 parts of hydrochloric acid is refluxed for 24 h, clear-filtered, allowed to come to room temperature and neutralized by addition of ca. 660 parts of sodium hydroxide solution (30 wt %) to pH 5-6 in that way that the temperature is maintained below 30° C. A mixture of 35 parts of salicylaldehyde and 71.5 parts of copper (II) sulfate pentahydrate in 380 parts of water is stirred for 30 min and treated with the latter mixture within 30 mm. The obtained suspension is refluxed for 30 min. filtered at 90° C. and the cake washed with water until salt-free, dried at 80° C. in vacuum to obtain 89 parts of greenish gray crystals of formula

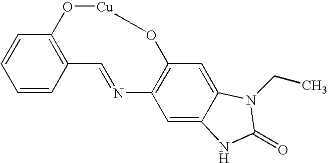

Mp>350° C.

C₁₆CuH₁₃N₃O₃ 358.8: C, 60.7; H, 4.2; N, 13.4% (found), C, 53.55; H, 3.65; N, 11.71% (required).

b) Condensation with 2-hydroxynaphthalene-1-carbaldehyde and Metallisation with Copper (II) Sulfate

A mixture of 100 parts of the manganese complex of example 1b and 956 parts of hydrochloric acid is refluxed for 24 h, clear-filtered, allowed to come to room temperature and neutralized by addition of ca. 660 parts of sodium hydroxide solution (30 wt %) to pH 5-6 in that way that the temperature is maintained below 30° C. A mixture of 50 parts of 2-hydroxynaphthaline-1-carbaldehyde and 71.5 parts of copper (II) sulfate pentahydrate in 380 parts of water is stirred for 30 min and treated with the latter mixture within 30 min. The obtained suspension is refluxed for 30 min, filtered at 90° C. and the cake is washed with water until salt-free, suspended in 900 parts of dimethylacetamide and refluxed for 1 h. The product is precipitated by addition of 950 parts of water, filtered and washed with water and dried in vacuum to obtain 57 parts of greenish gray crystals of the following formula

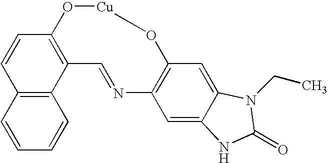

Mp>350° C.

### EXAMPLE 4

5-Amino-6-hydroxy-1,3-dihydrobenzimidazol-2-one, Hydrochloride

a) 5-Acetamino-1,3-dihydrobenzimidazol-2-one

was prepared analogously to example 1a to obtain 91% of beige-brown crystals of mp 353-356° C. of the following formula

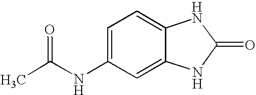

C_{ç}H₉N₃O₂=191.20: C, 56.0; H, 4.8; N, 21.4%(found), C, 56.54; H, 4.74; N, 22.00%(required).

b) 5-Acetamino-6-hydroxy-1,3-dihydrobenzimidazol-2-one, Manganese(II)Salt

A suspension of 100 parts of the amid obtained in Example 4a in 750 parts of acetic acid (80 wt %) and 75 parts of sulfuric acid (98 wt %) is cooled down to 5-10° C. and treated with 58 parts of manganese(IV) oxide, 90% activated, during 3.5 h. After 1 h additional stirring at 0-5° C., the excess of manganese(II) oxide is destroyed by dropwise addition of 25 parts of hydrogen peroxide (35 Wt %). After additional 30 min stirring, the product is filtered off and washed with water until salt free. The wet cake is suspended in 950 parts of dimethylformamide, stirred for 1 h, filtered off, washed with 140 parts of dimethylformamide and 1000 parts of water and dried in vacuum to obtain 44.5 parts of pale, fine crystals of mp>370° C. of the following composition

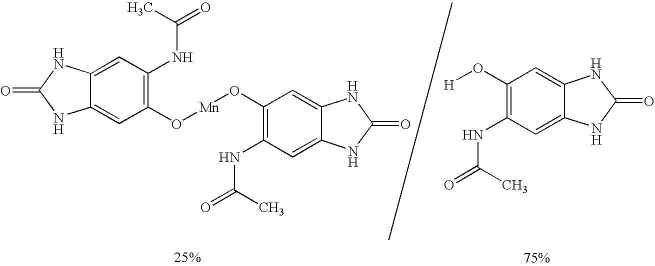

Yield: 33%

C₁₈H₁₆N₆O₆Mn (467.3)+C₉H₉N₃O₃ (207.2)=25/75: C, 50.7; H, 4.7; N, 19.6% (found), C, 50.69; H, 4.15; N, 19.71% (required)

c) 5-Amino-6-hydroxy-1,3-dihydrobenzimidazol-2-one, hydrochloride A mixture of 70 parts of the product obtained in example 4b and 750 parts of hydrochloric acid (35 wt %) are refluxed for 24 h under nitrogen atmosphere. The dark mixture is filtered under nitrogen and the filtrate is cooled down to room temperature. The cake is washed with water until salt free and dried in vacuum to obtain 41 parts of fine gray crystals of the following formula

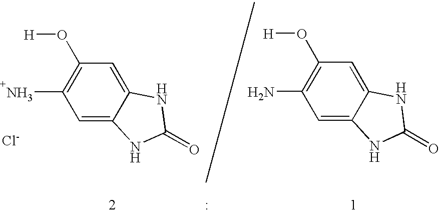

Yield: 79%

Mp: 304° C. (dec.)

C₇ClH₈N₃O₂ (201.6)/C₇H₇N₃O₂ (165.15)=2/1: C, 44.8; H, 4.5; N, 21.9; Cl 10.7 (found). C, 44.72; H, 4.08; N, 22.35; Cl 11.70% (required)

¹H-NMR (D₆-DMSO+NaOD, 300 MHz): δ 6.36 (s, 1H, H-4), 6.27 (s, 1H, H-7).

### EXAMPLE 5

Azo Colorants of 5-Amino-6-hydroxy-1,3-dihydrobenzimidazol-2-one

General Procedure—Saponification

A mixture of 37.4 parts of the product obtained in example 4b and 400 parts of hydrochloric acid, 34%, are refluxed for 16-24 h under nitrogen atmosphere. The dark solution is cooled down to 0-5° C. in an ice bath, and treated dropwise a 4N sodium nitrite solution until the nitrit-test (iodine-cadmium-paper) is positive. The excess of nitrite was destroyed by addition of a solution of sulfanilic acid (10 wt %). The obtained dark solution of the diazonium salt is directly used for coupling reaction.

General Procedure—Coupling

A mixture of 1.0 equivalents of coupling reagent (2.0 equivalents in the case of two coupling centers), 1.0 (2.0) equivalents of sodium hydroxide solution (30%) and 250 parts of water is could down to 0-5° C., stirred for 5 min and treated dropwise with the solution obtained above in that way, that the pH is maintained at 7-8 by time-to-time addition of sodium hydroxide solution and the temperature is kept below 10° C. The mixture is acidified by addition of hydrochloric acid, filtered, and the cake is washed with water until salt free and dried at 80° C. in vacuum.

| Example | Formula | color | IR (cm⁻¹) | Yield |
|---|---|---|---|---|
| 5a | 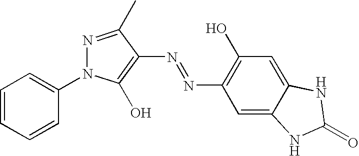 | Brown-yellow | 1708 1020 875 | 66% |
| 5b | 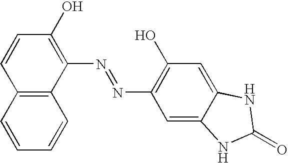 | Violet | 1703 1492 748 | Quant. |
| 5c | 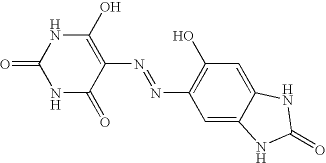 | orange | 1716 | Quant. |
| 5d | 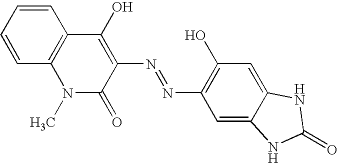 | red | 1704 1472 1279 | Quant. |
| 5e | 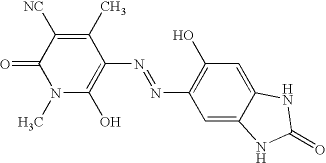 | red | 1703 1501 1010 | Quant. |
| 5f | 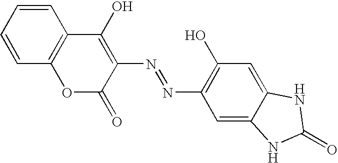 | orange | 1697 1501 1010 | Quant. |
| 5g | 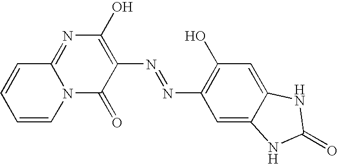 | red-brown | 1690 1648 1616 | 98 |
| 5h | 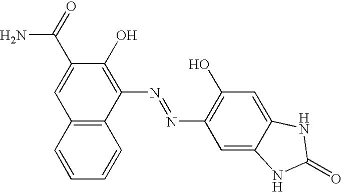 | violet | 1698 1479 1008 | 87 |
| 5j | 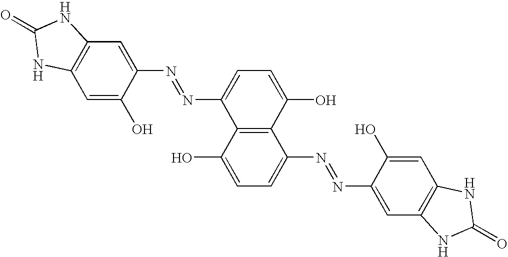 | Black | 1731 1699 806 | Quant. |
| 5k | 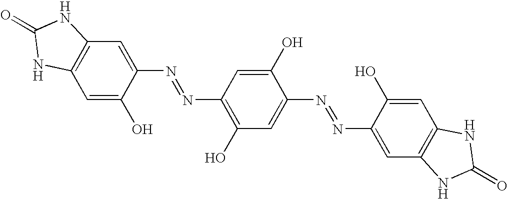 | Black | 1715 1473 | 89 |
| 5l | 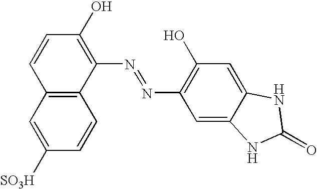 | Brown | 1700 1506 1033 987 | 68 |
| 5m | 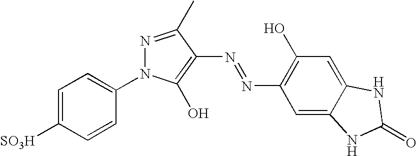 | orange-red | 1706 | Quant. |

### EXAMPLE 6

Azomethin Colorants of 5-amino-6-hydroxy-1,3-dihydrobenzimidazol-2-one

General Procedure for Azomethin Formation

A suspension of 16 parts of the aminophenol obtained in example 4c in 80-100 parts of dimethylformamide is heated to 60-80° C. and treated with 1 equivalent of the corresponding aldhyde. The mixture is kept at this temperature for further 2 h, filtered, washed with 80-100 parts of dimethylformamide and water until free of solvent and dried in vacuum to obtain 21-35 parts of the azomethin colorant. In the case the products are soluble, the mixture is diluted with 300-500 parts of water before isolating the products.

| Example | Formula | color | IR (cm⁻¹) | Yield (%) |
|---|---|---|---|---|
| 6a | 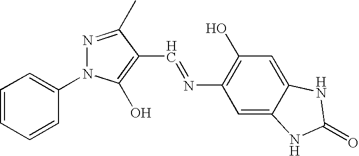 | Bright-yellow | 1706 1610 1597 1295 | 79 |
| 6b | 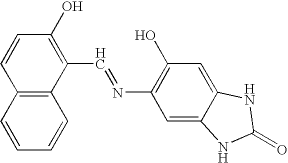 | Brown-yellow | 1710 | 56 |
| 6c | 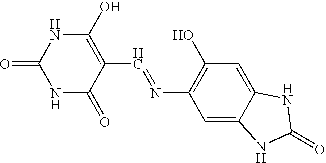 | Brown-yellow | 1715 1642 1324 | 93 |
| 6d | 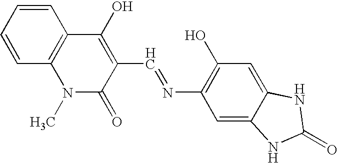 | Brown | 1710 1645 1556 | 89 |
| 6e | 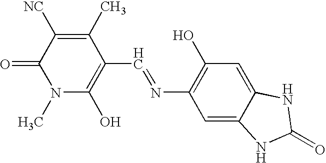 | Orange-brown | 2212 1694 1603 | 77 |
| 6f | 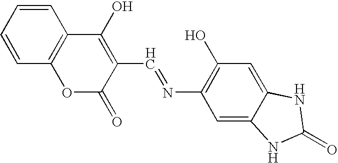 | Brown-yellow | 1694 1608 1494 | 84 |
| 6g | 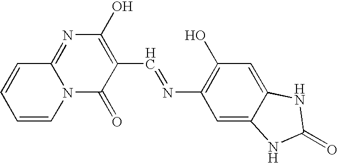 | Orange-brown | 1687 1573 1454 | 95 |
| 6h | 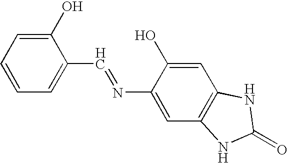 | Brown-yellow | 1729 1600 995 | 86 |
| 6j | 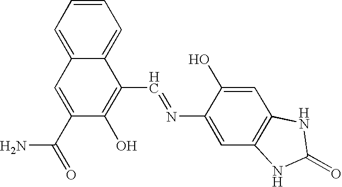 | brown | 1692 | 35 |
| 6k | 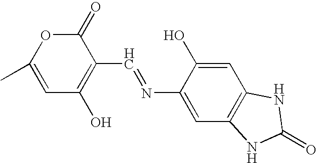 | Brown-yellow | 1702 | 30 |

### EXAMPLE 7

Metal Complexes of Azo and Azomethin Compounds

General Procedure

A mixture of 25 parts of dimethylformamide, 11 eqimol of metal salt (copper(I)sulfate, nickel(II)chloride, cobalt(II)sulfate, bariumchloride or calcium chloride), 1 part of sodium acetate, 2 parts of the azo or azomethine compound and 1 part of acetic acid is heated to 60° C. for 3 h. The suspension is filtered and the cake is washed with 15 parts of dimethylformamide and water until salt free and dried in vakuum at 80° C. to obtain 1-2 parts of metal complex. In the case TLC reveales large amounts of impurities, the products are suspended in dimethylformamide, heated for 1-2 h to reflux, filtered, washed with water and dried.

| Example | Ligand | Metal | color | IR (cm⁻¹) | Yield (%) |
|---|---|---|---|---|---|
| 7a | 2c | Cu | Brown-green | 1695 | 20 |
| 7b | 5a | Cu | Brown | 1699, 1474, 1005 | 80 |
| 7c | 5a | Co | Orange | 1692 | 57 |
| 7d | 5a | Ni | orange | 1695 | 62 |
| 7e | 5b | Cu | Brown-black | 1622 | Quant. |
| 7f | 5c | Co | bordeau | 1748, 1717, 1506, 1106 | 93 |
| 7g | 5c | Ni | bordeau | 1747, 1716, 1645, 1404 | 47 |
| 7h | 5d | Cu | Red violet | 1710, 1487, 1325, 754 | 89 |
| 7j | 5e | Cu | Green-grey | 2227, 1753, 1480 | 78 |
| 7k | 5f | Cu | Red brown | 1695, 1521, 1361, 1294 | 95 |
| 7l | 5g | Cu | Brown | 1704, 1151, 1107, 753 | 93 |
| 7m | 5h | Cu | Black-brown | 1693 | 68 |
| 7n | 5j | Cu | Black | 1690 | Quant. |
| 7o | 5k | Cu | Black-brown | 1713, 1472, 1161. 1014 | 50 |
| 7p | 6a | Cu | Brown | 1697, 1613, 1334 | 85 |
| 7q | 6a | Co | Yellow | 1715, 1659, 1290 | 83 |
| 7r | 6b | Cu | Green-brown | 1721, 1595, 1578, 1539 | 86 |
| 7s | 6e | Cu | Yellow-green | 2217, 1698, 1593, 1542, 1489 | 81 |
| 7t | 6f | Cu | Brown | 1711, 1667, 1184, 759 | 76 |
| 7u | 6g | Cu | Orange-brown | 1686, 1570, 1454, 1361 | 75 |
| 7v | 6h | Cu | Yellow-green | 1728, 1704, 1605 | 50 |
| 7w | 6j | Cu | Brown | 1681, 1647, 1624, 1484 | 58 |

### EXAMPLE 8

Laked Pigments

A mixture of 10 parts of the azo or azomethine colorant and 150 parts of water is adjusted to pH 10-11 by addition of sodium hydroxide solution, 30%. A solution of 0.5 equivalents of calcium chloride or bariumchloride is added and the mixture is stirred for 2h. The pH is adjusted to 7 by addition of hydrochloric acid, the pigment is filtered off, washed with water and dried to obtain 9-11 parts of product.

| Ex- | Li- | | | | Yield |
|---|---|---|---|---|---|
| ample | gand | Metal | color | IR (cm⁻¹) | (%) |
| 8a | 5l | Ca | violet | 1697, 1478, 1034 | 93 |
| 8b | 5m | Ca | Orange-red | 1710, 1660, 1038, 1010 | 69 |
| 8c | 5m | Ba | Orange-red | 1704, 1657, 1036, 1009 | 69 |

### EXAMPLE 10

Oxidation of 2-acetaminoacridone

a) Acetylation of 2-aminoacridone

A mixture of 21 parts of the 2-aminoacridone in 200 parts of glacial acetic acid is treated with 11 parts of acetanhydride and stirred for 1 h. The precipitate is filtered off and washed with water until free of acid and dried in vacuum to obtain 24 parts of a gray-green compound of the following formula

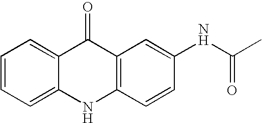

Yield: 96%

IR: δ(cm⁻¹) 3252, 3176, 1658, 1631, 1602, 1580, 1152, 750

mp: 382-384° C. (dec.)

b) Oxidation and Saponification of 2-acetaminoacridone

A mixture of 20 parts of the compound obtained in example 10a and 100 parts of glacial acetic acid is treated dropwise with a mixture of 11 part of manganese dioxide, 1.5 parts of water and 1.5 parts of conc. sulfuric acid and strirred overnight at room temperature. The precipitate is filtered off, washed with water until free of acid, and dried in vacuum to obatain 16 parts of a material that contains still manganese dioxide. This material is treated with 200 parts of concentrated hydrochloric acid, refluxed for 3h, filtered at room temperature, washed with water to obtain 7 parts of the hydrochloride of a compound of the following formula

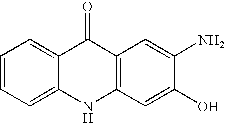

Yield: 31%

IR: δ(cm⁻¹) 3233 (br), 1622, 1442, 1157, 755

mp: 340-341° C. (dec.)

Application in PVC

The preparation of a 0.1% colored PVC sheet is performed following the procedure:

100 g of PVC-white (0.5% TiO₂) are mixed with 0.1 g of pigment of example 5a for 2 minutes. The mixture is passed between two rollers for 8 minutes, the front roller being heated at 160° C. and the rear roller being heated at 165° C. Then the sheet is pressed under a pressure of 25 tones between two chromium-plated steel plates heated at 160° C., for 5 minutes. The sheet gives a yellow-orange shade.

Application in Lacquers Masstone

The preparation of the alkydmelamine (AM5) resin coating is performed following the procedure:

3.6 g of pigment obtained in example 3b, 26.4 g of clear AM5 (35%) and 85 g of glass beads are stirred in a Skandex stirrer for 30 minutes. 30 g of this preparation are mixed with 60 g of clear AM5 (55.8%). The dispersion is sprayed on a cardboard sheet, air-dried for 15 minutes and baked at 140° C. in an oven for 30 minutes.

Application in Lacquers White

The preparation of the alkydmelamine (AM5) resin coating is performed following the procedure:

3.6 g of pigment obtained in example 3b, 26.4 g of clear AM5 (35%) and 85 g of glass beads are stirred in a Skandex stirrer for 30 minutes. 7.5 g of this preparation are mixed with 20 g of AM5-white (30% TiO₂). The dispersion is sprayed on a cardboard sheet, air-dried for 15 minutes and baked at 140° C. in an oven for 30 minutes.

USE EXAMPLE 1
Application in AM5 lacquers

| Use example | Compound | Color in AM5 resin |
|---|---|---|
| 1a | 2b | Red-violet |
| 1b | 2c | Orange |
| 1c | 2d | Yellow |
| 1d | 3a | Green-yellow |
| 1e | 3b | Brown-yellow |
| 1f | 5a | Orange |
| 1g | 5d | Red |
| 1h | 5e | Red-gray |
| 1j | 5f | Red |
| 1k | 5j | Black |
| 1l | 6a | Yellow |
| 1m | 6g | Yellow-orange |
| 1n | 7h | Red-brown |
| 1o | 7j | Gray-violet |
| 1p | 7k | Red-brown |
| 1q | 7l | Brown-gray |
| 1r | 7n | Black |
| 1s | 7p | Brown |
| 1t | 7q | Yellow |
| 1u | 7r | Green-yellow |
| 1v | 7s | Green-yellow |
| 1w | 7t | Brown-yellow |
| 1x | 7u | Yellow-brown |
| 1y | 7v | Brown-yellow |
| 1z | 8b | Orange-red |
| 1aa | 8c | Orange-red |

USE EXAMPLE 2
Application in PVC

| Use example | Compound | Color in AM5 resin |
|---|---|---|
| 2a | 2b | Red-violet |
| 2b | 2c | Orange |
| 2c | 2d | Yellow |
| 2d | 2e | Yellow-orange |
| 2e | 3a | Green-yellow |
| 2f | 5a | Orange |
| 2g | 5j | Black |
| 2h | 7b | Brown-orange |
| 2j | 7c | Orange |
| 2k | 7d | Orange |
| 2l | 7n | Black |
| 2m | 7p | Green-yellow |
| 2n | 7q | Green-yellow |
| 2o | 7r | Brown-yellow |
| 2p | 7s | Yellow-brown |
| 2q | 7t | Brown-yellow |
| 2r | 8b | Orange-red |
| 2s | 8c | Orange-red |

1. Aminophenols of the general formula (I) 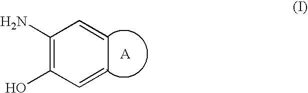
in which ring A is an anellated ring which is fused on in 3,4- or 4,5- or 5,6-position and selected from the group consisting of the moieties (1) to (6) 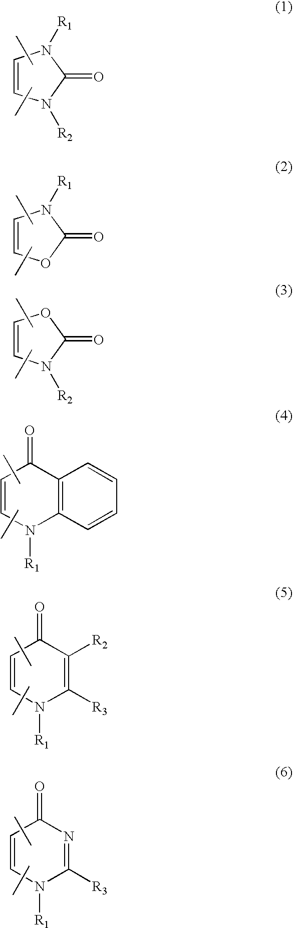
wherein R₁ and R₂ are, independently from each other, hydrogen, C₁₋₈alkyl, C₅₋₆ cycloalkyl, benzyl, phenyl or naphthyl whereby phenyl and naphthyl groups may be mono- or poly-substituted by radicals selected from the group halogen, nitro, C₁₋₈alkyl, C₅₋₆cycloalkyl, benzyl, phenyl or naphthyl, COOalkyl, C₁₋₃alkoxy or trifluoromethyl and R₃ is, independently from R₁ and R₂, hydrogen, hydroxy, C₁₋₈alkyl, C₅₋₆ cycloalkyl, benzyl, phenyl or naphthyl whereby phenyl and naphthyl groups may be mono- or poly-substituted by radicals selected from the group halogen, nitro, C₁₋₈alkyl, C₅₋₆cycloalkyl, benzyl, phenyl or naphthyl, COOalkyl, C₁₋₃alkoxy or trifluoromethyl, with the proviso that for moiety (1) R₁ and R₂ both being methyl is excluded.

2. Compounds according to claim 1 of the formula (Ia) 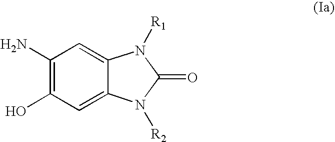
in which R₁ and R₂ are defined as in claim 1.

3. Azo compounds of the general formula (II) 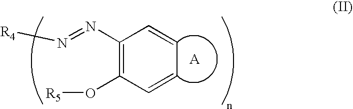
in which ring A has the meaning given in claim 1, n is 1 or 2 and
for n being 1 R₄ is selected from the group of 1-or 2-hydroxy naphthyl, 2-hydroxy benzene, 1-phenyl-pyrrazol-5-one, 4-hydroxy-2-cumarone, 4-hydroxy-2-pyrone, 2-hydroxy-4-oxopyrido[1,2-b]pyrimidine, 4-hydroxy-2-quinolone, pyrimidine-2,4,6-trione and acetoacetyl phenylamide,
for n being 2 R₄ is 1,4-dihydroxy phenyl, 1,5-dihydroxy naphtyl or bis(acetoacet)phenylen diamide,
whereby pyrimidine and quinolone maybe present in the N—H, N-methyl or N-ethyl form,
the benzo, phenyl and naphthyl groups may be mono- or poly-substituted by radicals selected from the group amino, phenylazo, naphthylazo, hydroxy, halogen, nitro, C₁₋₈alkyl, C₅₋₆cycloalkyl, benzyl, phenyl or naphthyl, hydroxycarbonyl, COOalkyl, C₁₋₃alkoxy, sulfonyl, aminocarbonyl, aminosulfonyl, C₁₋₈alkylaminosulfonyl, hydroxysulfonyl or trifluoromethyl whereby phenyl and naphthyl can be mono- or poly-substituted by radicals selected from the group amino, hydroxy, halogen, nitro, C₁₋₈alkyl, C₅₋₆cycloalkyl, benzyl, phenyl, aminophenyl, COOalkyl, C₁₋₃alkoxy, aminocarbonyl, aminosulfonyl. C₁₋₈alkyl or trifluoromethyl, said sulfonyl groups optionally being present in form of calcium, barium, ammonium or alkali, preferably sodium, salts and R₅ is hydrogen or copper, cobalt or nickel.

4. Compounds according to claim 3 of the formula (IIa) 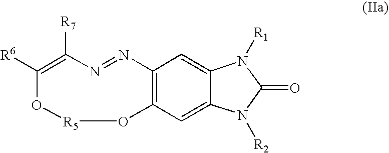
in which R₁, R₂ and R₅ have the meanings given in claim 1 and 3 and R₆ and R₇ together are a benzo or naphtho-ring, a 4-methyl-1-phenyl pyrazol-5-one, 2-cumarone, 2-pyrone, 4-oxopyrido[1,2-b]pyrimidine, 2-quinolone, pyrimidine-2,4,6-trione-ring or Rr is methyl and R₇ is phenyl aminocarbonyl whereby benzo, naphtho, phenyl and further attached benzorings can be mono- or poly-substituted by radicals selected from the group amino, phenylazo, naphthylazo, 2-hydroxyphenylazo, hydroxynaphthylazo, phenylaminocarbonyl, hydroxy, halogen, nitro, C₁₋₈alkyl, C₅₋₆cycloalkyl, benzyl, phenyl, aminophenyl, hydroxycarbonyl, COOalkyl, C₁₋₃alkoxy, aminocarbonyl, aminosulfonyl, C₁₋₈alkylaminosulfonyl, sulfonyl or trifluoromethyl, said sulfonyl groups optionally being present in form of calcium, barium, ammonium or alkali, preferably sodium, salts.

5. Compounds according to claim 4 of the formulae (IIb) or (IIc) 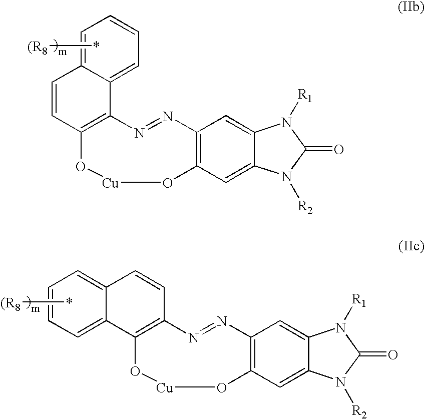
in which R₁, R₂ have the meanings given in claim 2, m is 1, 2 or 3 and R₈ is located in the 3, 6 or 7 position of the naphthalene system and selected from hydrogen, hydroxycarbonyl, aminocarbonyl, sulfonyl, aminosulfonyl, halogen, amino, phenylazo, naphthylazo, phenylaminocarbonyl whereby phenyl and naphthyl can be mono- or poly-substituted by radicals selected from the group hydroxy, halogen, nitro, C₁₋₈alkyl, C₅₋₆cycloalkyl, benzyl, phenyl, aminophenyl, COOalkyl, C₁₋₃alkoxy, aminosulfonyl, C₁₋₈alkyl sulfonyl or trifluoromethyl and said sulfonyl groups may optionally be present in form of calcium, barium, ammonium or alkali, preferably sodium, salts.

6. Azomethin compounds of the general formula (III) 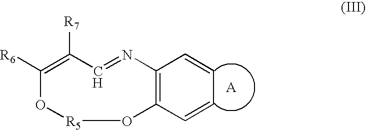
in which ring A and R₅ have the meaning given in claim 3 and R₆ and R₇ have the meaning given in claim 4.

7. Azomethin compounds according to claim 6 of the formula (IIIa) 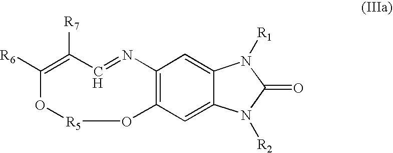
in which ring R₁, R₂, R₅, R₆ and R₇ have the meaning given in claim 4.

8. Azomethin compounds according to claim 7 of the formula (IIIb) 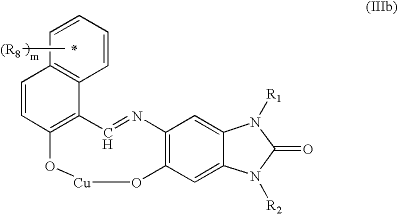
in which R₁, R₂, m and R₈ have the meanings as defined in claim 5.

9. Process for the preparation of aminophenol compounds of formula (I) according to claim 1 by oxidation with manganese dioxide in the presence of sulfuric acid and subsequent saponification of the resulting intermediate compounds under basic or acidic conditions of amides of formula (IV) 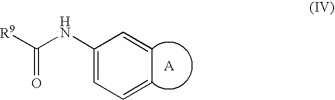
wherein ring A has the meaning given in claim 1 and R₉ is hydrogen, methyl or phenyl.

10. Process for the preparation of aminophenol compounds of formula (I) according to claim 1 characterized by the following reaction path 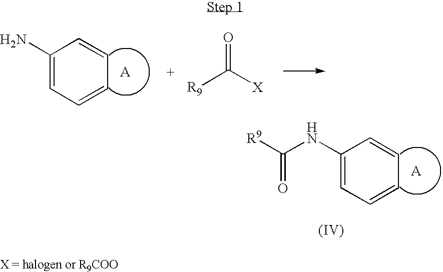 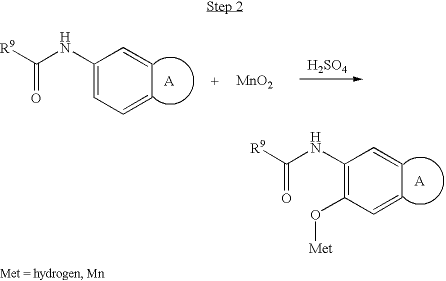 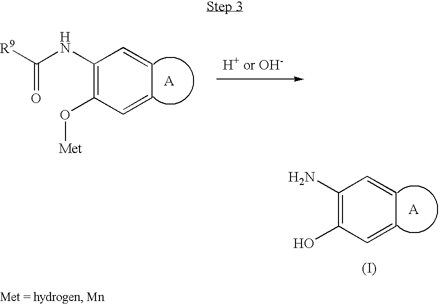
wherein ring A has the meaning given in claim 1 and R₉ is hydrogen, methyl or phenyl.

11. Use of the compounds of the formula (I) according to claim 1 as intermediates, isolated or not isolated, for the preparation of compounds (II) according to claim 3.

12. Use of the compounds of the formula (I) according to claim 1 as intermediates, isolated or not isolated, for the preparation of compounds (III) according to claim 6.

13. Use of the compounds of the formula (II) according to claim 3 as pigments or dyes.

14. Use according to claim 13 as colorants for coloring polymer compositions or paper pulps, as colorants in electro-photographic toners and developers, as colorants in inkjet inks, as colorants in the coatings' industry, as colorants for textile printing, as a printing ink in the graphical industry or as colorant in cosmetics.

15. Use of the compounds of the formula (III) according to claim 6 as pigments or dyes.

16. Use according to claim 15 as colorants for coloring polymer compositions or paper pulps, as colorants in electro-photographic toners and developers, as colorants in ink-jet inks, as colorants in the coatings' industry, as colorants for textile printing, as a printing ink in the graphical industry or as colorant in cosmetics.
